(19) United States
(12) Patent Application Publication
(10) Pub. No.: US 2007/0248940 A1
(43) Pub. Date: Oct. 25, 2007

(54) METHOD OF TEACHING CHILDREN TO RECYCLE USING A PLUSH TOY

(76) Inventor: Ryan H. Maguire, Saunderstown, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/739,409

(22) Filed: Apr. 24, 2007

Related U.S. Application Data
(60) Provisional application No. 60/745,421, filed on Apr. 24, 2006.

(51) Int. Cl. G09B 23/00; A63H 3/02

(52) U.S. Cl. 434/276; 446/369

(57) ABSTRACT

A method of teaching recycling to children using a plush toy body shell having a closeable opening into an interior portion of the plush toy body shell is disclosed. In a first step recyclable material is provided. In a second step, the child is instructed to insert the recyclable material in the interior portion of the plush toy body shell until the plush toy body shell is filled with recyclable material. In a third step, the child is instructed to close the opening of the plush toy body shell to make a complete stuffed toy.

### CROSS-REFERENCE TO RELATED APPLICATION

The present application claims priority to earlier filed U.S. Provisional Patent Application Ser. No. 60/745,421, filed Apr. 24, 2006, the contents of which are incorporated herein by reference.

### BACKGROUND OF THE INVENTION

1. Field of the Invention

The present invention relates generally to methods of recycling waste and more particularly to a method of teaching children the necessity of recycling waste and keeping the environment clean through use of a plush toy.

2. Background of the Related Art

The proposition that protection of the environment is critical to the long term wellbeing of millions of species of life, including the human race, is now generally well accepted. Recycling is a key element to ensuring that the environment is not irreversibly contaminated by the human race's commercial industries because it eases the burden on our already crowded landfills. By preventing waste materials from finding its way into a landfill, or worse, into the wild where animals may come into contact with the material, the environment is spared one less piece of man-made contaminates. Engineered materials, especially products that derive from oil, such as plastics and polystyrene, can last for many thousands of years without any noticeable decomposition.

Besides the inherent toxicity of any one material, the waste material itself can pose as a significant hazard to many wild and domestic animals. In particular, soda six pack rings and plastic grocery bags are a well-known to be strangulation hazards to many birds and small animals. Foam packing peanuts and other plastic materials can also pose a serious hazard to animals that ingest them.

Teaching children at an early age to recycle is paramount to ensuring that tomorrow's world will be a better place. However, to teach children effectively, it is always advantageous to turn any type of learning activity into a game to ensure the child retains the concepts long after the game is forgotten.

Therefore, there is a need for a fun and entertaining way to teach children about recycling that will encourage the children to recycle now and in the future.

### SUMMARY OF THE INVENTION

The present invention solves the problems of the prior art by providing a novel method of teaching children the necessity of recycling waste materials, such as paper and plastic bags, newspapers, cardboard, magazines, plastic bottles, etc., in a fun and enjoyable manner. In particular, the method of the present invention includes providing a plush toy shell and further providing non-biodegradable waste, such as polystyrene peanuts, plastic bags, bubble wrap, an other waste material, to be used as filler or stuffing material for the plush toy shell. In a further step, children are taught to stuff the plush toy shell with the waste stuffing material, which creates a plush toy for the children to enjoy. By presenting recycling in a fun learning environment, children can be ingrained at an early age the importance of keeping the environment clean. In addition, children can also learn how items that are considered waste refuse can be re-purposed, “recycled”, and used to function in an all new way.

### BRIEF DESCRIPTION OF THE DRAWINGS

These and other features, aspects, and advantages of the present invention will become better understood with reference to the following description, appended claims, and accompanying drawings where:

FIG. 1 is a flow chart of the preferred embodiment of the method of the present invention;

FIG. 2 is a front plan view of a plush toy body shell that could be used in conjunction with the method shown in FIG. 1;

FIG. 3 is a rear plan view of the plush body shown in FIG. 2;

FIG. 4 is a perspective view of recyclable material; and

FIG. 5 is a perspective view of a user inserting recyclable material into the interior cavity of the plush body;

FIG. 6 is a perspective view of the user closing the opening of the plush body; and

FIG. 7 is a perspective view of the finished stuffed toy.

### DESCRIPTION OF THE PREFERRED EMBODIMENT

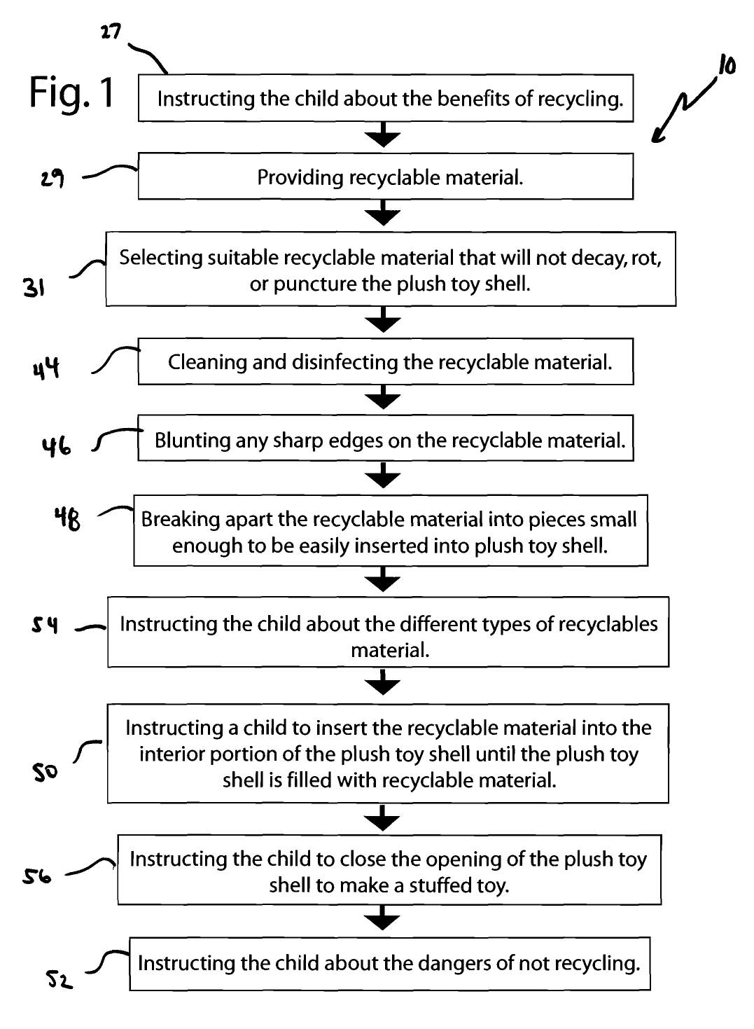

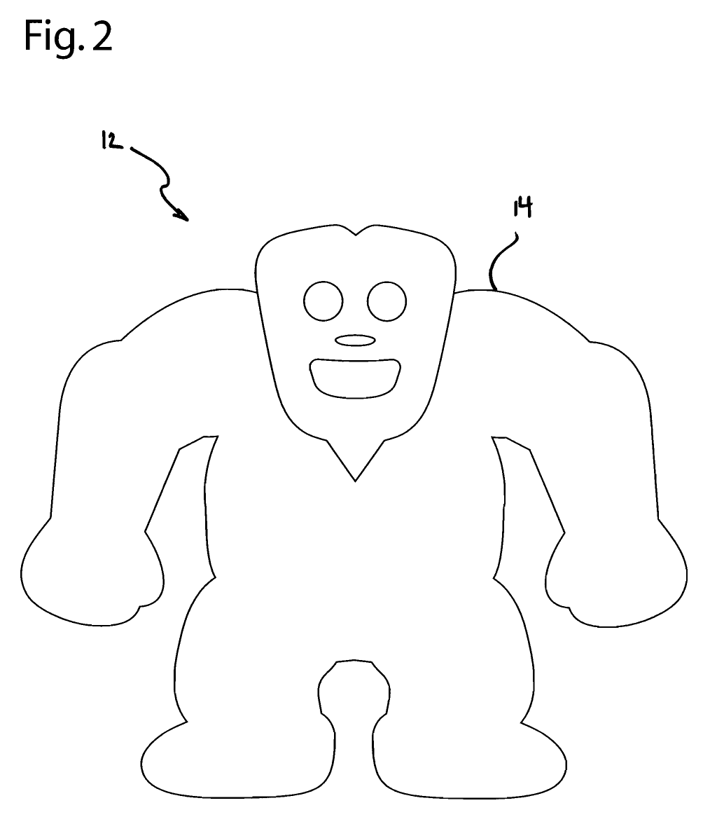

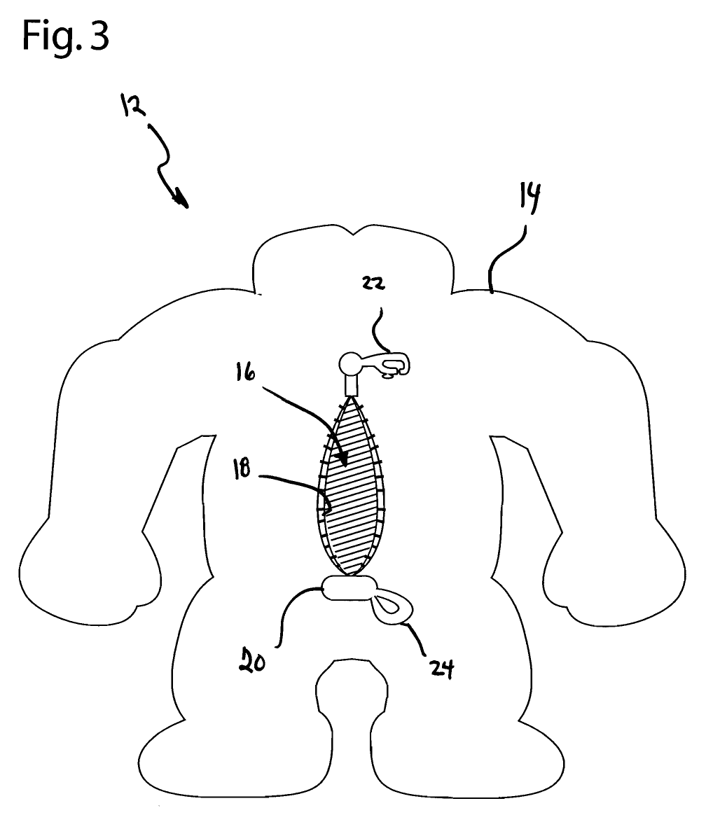

Referring to FIG. 1, the method of the present invention is generally shown at 10, which includes a number of steps to teach a child the importance of recycling. Referring to FIGS. 2 and 3, illustrate is an embodiment of a plush toy body shell 12 that can be used to implement the method 10 of the present invention. In particular, the plush toy body shell 12 has a soft and flexible ornamental exterior 14 that is configured to be the shape and likeness of a cartoon character that children find appealing. Preferably, the plush toy body shell 12 is constructed of a material that has resiliency and can stretch, however, conventional clothes and felts may also be used.

Referring to FIG. 3, the plush toy body shell 12 has an interior portion 16 that is accessed through an opening 18 formed on the rear or on an edge of the plush toy body shell 12. Preferably, the opening 18 may be fastened closed with a zipper 20, although other fasteners, such as hook-and-loop fasteners or buttons may also be used. It is important to select a fastener that children can safely and easily operate. Preferably, the fastener would also include a feature to prevent the fastener from accidentally opening. In the case of a zipper 20, it would be preferable to include a clip 22 to secure the zipper pull 24 to prevent the zipper 20 from opening.

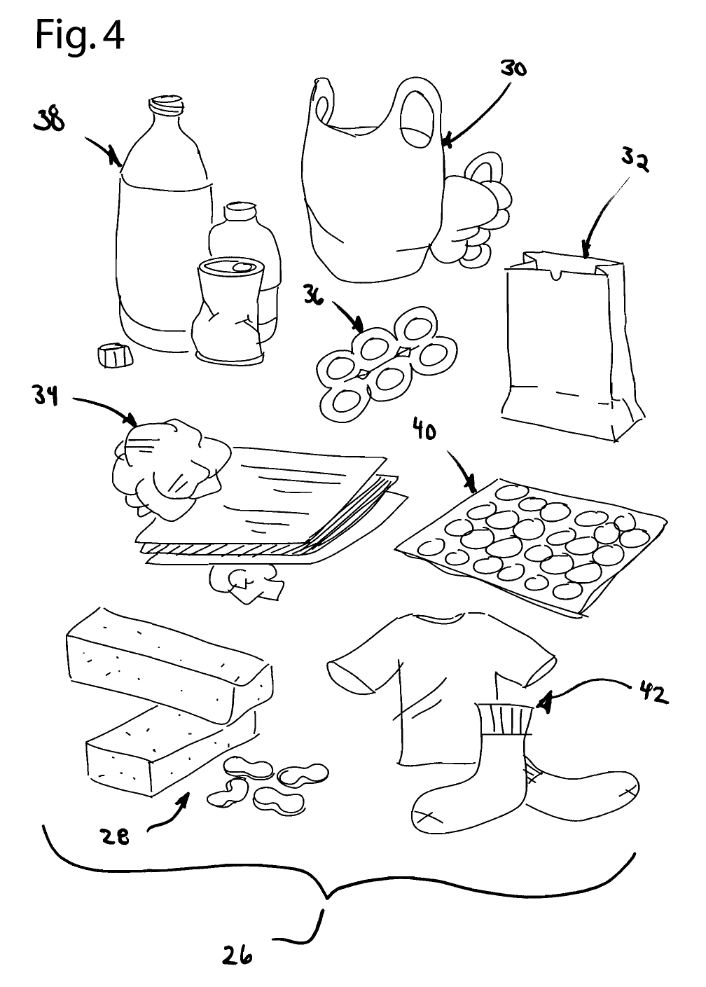

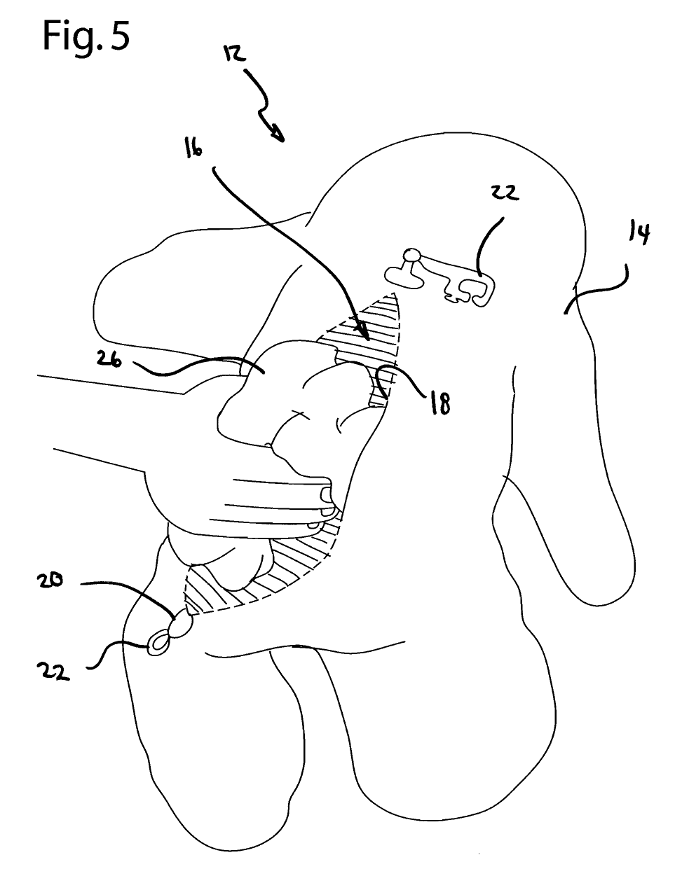

Using the plush toy body shell 12, a parent or teacher can instruct a child or children to recycle waste by stuffing the interior portion 16 of the plush toy body shell 12 with various waste materials 26. In particular, the parent or instructor may instruct the child about the benefits of recycling in a first step 27. The parent or instructor can provide recyclable material 26 from the trash in a second step 29. Referring to FIG. 4 and step 31 from FIG. 1, the parent and child must select suitable waste material, such as polystyrene packing peanuts and packing foam 28, plastic grocery bags 30 and paper grocery bags 32, full-color paper flyers and waste paper 34, plastic soda six pack rings 36, plastic and aluminum containers 38, bubble wrap 40, and old clothes 42. The method of the present invention, however, may be use with any recyclable material 26 and the aforementioned types of recyclable material 26 are listed by means of example and not a limitation. The waste material 26 should be washed and/or disinfected prior to using the material to ensure no chemicals, dirt, or food is still clinging to the material as shown in step 44 of FIG. 1. Additionally, plastic waste material that has sharp edges should be avoided, or alternatively, the parent should blunt the sharp edges as shown in step 46 of FIG. 1. The parent and child can tear or cut up larger pieces of waste to form more appropriate sized pieces as another step 48. The child and parent can then take turns stuffing suitably sized pieces of waste material 26 as filler into the interior 16 of the plush toy body shell 14 as shown in FIG. 5 and step 50 of FIG. 1.

The parent and child continue stuffing the plush toy body, ensuring that all corners of the interior are filled with the waste material collected earlier. As the parent or instructor is working with the child, they can instruct the child about the importance of maintaining a clean environment and the many benefits of recycling 27. Moreover they can instruct the child of the dangers of not recycling 52. In addition, the parent or instructor can discuss with the child the properties and characteristics of the different types 54 of recyclable material 26. For instance, the parent or instructor can inform the child about the longevity of plastics and polystyrene in the environment and the dangers that soda six-pack rings pose to animals.

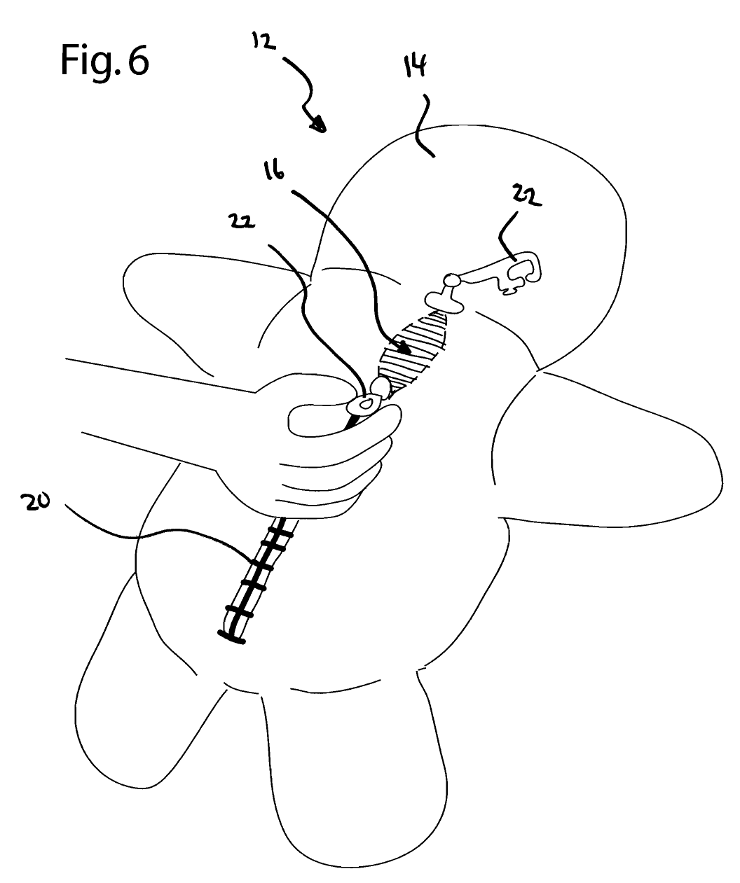

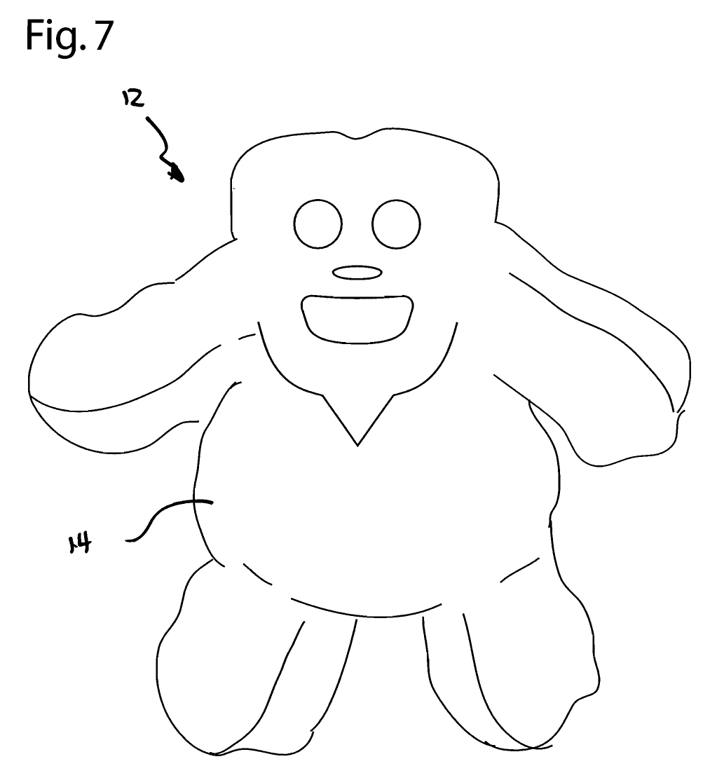

Once the interior of the plush toy body is filled, the fasteners on the opening can be secured to complete the plush toy that the child can play with as shown in FIGS. 6 and 7 and step 56 of FIG. 1. Through creating the plush toy, the child has had an opportunity to learn the concept of recycling in a fun and engaging activity.

Therefore, it can be seen that the present invention provides a unique solution to the problem of teaching children to recycle solid waste, such as plastic, polystyrene, bubble wrap, old clothes, old newspaper and magazines, and the like.

It would be appreciated by those skilled in the art that various changes and modifications can be made to the illustrated embodiments without departing from the spirit of the present invention. All such modifications and changes are intended to be within the scope of the present invention except as limited by the appended claims.

I claim:

1. A method of teaching recycling to children using a plush toy body shell having a closeable opening into an interior portion of the plush toy body shell, comprising the steps of:
providing recyclable material;
instructing a child to insert the recyclable material in the interior portion of the plush toy shell until the plush toy shell is filled with recyclable material; and
instructing the child to close the opening of the plush toy body shell to make a stuffed toy.

2. The method of claim 1, further comprising the step of:
instructing the child about the benefits of recycling.

3. The method of claim 1, further comprising the step of:
instructing the child about the dangers of not recycling.

4. The method of claim 1, further comprising the step of:
instructing the child about the different types of recyclable material.

5. The method of claim 1, further comprising the step of:
cleaning and disinfecting the recyclable material.

6. The method of claim 1, further comprising the step of:
selecting suitable recyclable material that will not decay, rot or puncture the plush toy body shell.

7. The method of claim 1, further comprising the step of:
blunting any sharp edges on the recyclable material.

8. The method of claim 1, further comprising the step of:
breaking apart the recyclable material into pieces small enough to be easily inserted into the plush toy body shell.

9. The method of claim 1, wherein the recyclable material is selected from the group comprising: newspaper, waste paper, polystyrene packing peanuts, plastic grocery bags, full-color paper flyers, old clothes, bubble wrap, and plastic soda six-pack rings.

10. A method of teaching recycling to children using a plush toy body shell having a closeable opening into an interior portion of the plush toy body shell, comprising the steps of:
providing recyclable material;
inserting the recyclable material in the interior portion of the plush toy body shell until the plush toy body shell is filled with recyclable material; and
closing the opening of the plush toy body shell to make a stuffed toy.

11. The method of claim 10, further comprising the step of:
instructing the child about the benefits of recycling.

12. The method of claim 10, further comprising the step of:
instructing the child about the dangers of not recycling.

13. The method of claim 10, further comprising the step of:
instructing the child about the different types of recyclable material.

14. The method of claim 10, further comprising the step of:
cleaning and disinfecting the recyclable material.

15. The method of claim 10, further comprising the step of:
selecting suitable recyclable material that will not decay, rot or puncture the plush toy body shell.

16. The method of claim 10, further comprising the step of:
blunting any sharp edges on the recyclable material.

17. The method of claim 10, further comprising the step of:
breaking apart the recyclable material into pieces small enough to be easily inserted into the plush toy body shell.

18. The method of claim 10, wherein the recyclable material is selected from the group comprising: newspaper, waste paper, polystyrene packing peanuts, plastic grocery bags, full-color paper flyers, old clothes, bubble wrap, and plastic soda six-pack rings.
